(19) United States
(12) Patent Application Publication
(10) Pub. No.: US 2013/0006817 A1
(43) Pub. Date: Jan. 3, 2013

(54) ENABLING CONTROL OR USE OF PERSONAL METADATA

(75) Inventors: Karon A. Weber, Kirkland, WA (US); Jennifer L. Rodenhouse, Seattle, WA (US)

(73) Assignee: Microsoft Corporation, Redmond, WA (US)

(21) Appl. No.: 13/175,172

(22) Filed: Jul. 1, 2011

(51) Int. Cl. G06F 17/30; G06Q 30/00

(52) U.S. Cl. 705/27.1; 707/736; 707/737; 707/E17.005; 707/E17.046

(57) ABSTRACT

This document describes techniques and apparatuses for enabling control or use of personal metadata. In some embodiments, the techniques assemble a person's metadata from various sources on the Internet, present the person's metadata in a user interface, and enable the person to control his or her metadata by adding, removing, or weighting portions of the metadata. By so doing, the techniques enable people to know and alter their metadata, which permits them to tailor their interactions with the Internet or improve their reputation or security.

### BACKGROUND

People interact with the Internet in many different ways—they read articles, search for products or information, buy items, and record social events. Each of these interactions can create metadata about the person interacting with the Internet and even other persons that are not interacting, such as when a person uploads a picture of herself and a friend, thereby creating metadata about herself and the friend.

Personal metadata is important. A person's metadata affects a person's online and real-life reputation. A person's metadata can also affect future interactions within the Internet, generally because entities on the Internet have portions of this metadata that they use to tailor interactions with the person. Further still, this metadata can be used in ways a person usually does not want, such as to contact the person (e.g., with email spam), steal a person's identity, or expose private information.

### SUMMARY

This document describes techniques and apparatuses for enabling control or use of personal metadata. In some embodiments, the techniques assemble a person's metadata from various sources on the Internet, present the person's metadata in a user interface, and enable the person to control his or her metadata by adding, removing, or weighting portions of the metadata. By so doing, the techniques enable people to know and alter their metadata, which permits them to tailor their interactions with the Internet or improve their reputation or security.

This summary is provided to introduce simplified concepts for enabling control or use of personal metadata, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses for enabling control or use of personal metadata are described with reference to the following drawings. The same numbers are used throughout the drawings to reference like features and components:

FIG. 1 illustrates an example environment in which techniques for enabling control or use of personal metadata can be implemented.

FIG. 2 is a more-detailed illustration of computing devices illustrated in FIG. 1.

FIG. 3 is a more-detailed illustration of the remote device of FIG. 1.

FIG. 4 illustrates an example method for enabling control or use of personal metadata.

FIG. 5 illustrates the user interface of FIG. 1 having personal metadata grouped by subject and influence.

FIG. 6 illustrates the user interface of FIG. 5 after the personal metadata has been altered.

FIG. 7 illustrates an example method for enabling control or use of personal metadata where the control or use results in broadcast of personal metadata to one or more entities.

FIG. 8 illustrates an example device in which techniques for enabling control or use of personal metadata can be implemented.

### DETAILED DESCRIPTION

### Overview

This document describes techniques and apparatuses for enabling control or use of personal metadata. By way of example, consider a simple case of a person named Lydia that has only interacted with the Internet three times. In her first interaction, Lydia buys a pair of ballet shoes from ShoeStore.com. This interaction results in the following metadata being created and associated with Lydia: Lydia's full name, the address where the shoes were shipped, all of the information about Lydia's credit card, the price of the shoes, the size of the shoes, the type of the shoes (ballet), and when and where the shoes were purchased (ShoeStore.com).

In her second interaction, Lydia searches, through a search engine on her smart phone, for a movie currently in theaters. This interaction results in the following additional metadata being created and associated with Lydia: the geographic location of Lydia's smart phone, the search terms (“animated movies”), the smart phone's identity and its type, when the search was made, the results presented for the search, and any selection by Lydia of the results.

In her third interaction, Lydia joins a social-networking website and enters her first post where she uploads a picture of herself and a friend at the movie she found in her search. This interaction results in the following additional metadata: everything Lydia entered when she joined the website, such as age, gender, address, photo or avatar, and interests; any friends, influences, or media associated with her post or mentioned in her post; her friend's name and photo if Lydia tagged the photo with her friend's name; Lydia's photo if tagged; and the text she entered in her first post (“Great Fun at Tangled with Amelia!”).

Even for this simple case of only three interactions with the Internet, Lydia's metadata is already substantial. Current techniques permit Lydia little or no control or knowledge of her metadata and then only if she contacts the entities she interacted with—the shoe store, the search engine, and the social networking site—much less most or all of the metadata about her on the Internet. A person with hundreds or thousands of interactions would very likely not even know where to look for his or her metadata, much less be able to meaningfully control it or how it is used.

The techniques described herein, however, enable people to control and/or use their metadata. In Lydia's case, for example, the techniques can assemble her metadata, present her assembled metadata in a user-friendly interface, and enable her to control this metadata. Lydia can see that her metadata includes her address and credit card number, that she went to the movie Tangled, and that she bought the ballet shoes.

Lydia can control this metadata; assume that she does not want her address and credit card number available to any entities (including ShoeStore.com). The techniques permit her to remove these after which the techniques can contact ShoeStore.com and tell them to remove this information. Assume that Lydia does not often use the shoes—they were for ballet, but her interests are now more in tennis and basketball. The techniques permit her to down-weight the shoes so that future interactions are not heavily weighted toward ballet.

Assume also that Lydia loved the movie Tangled. The techniques permit her to up-weight metadata for Tangled so that future searches, recommendations, and her online presence reflect that she really liked the movie. If Lydia then enters “comedy movie” in an Internet search, for example, her altered metadata may cause the search engine to down-list (or not list) a comedy about ballet but up-list an animated movie having a heroine displaced from her real mother (e.g., Cinderella) relative to a search using her unaltered metadata.

This is but one example of how techniques for enabling control or use of personal metadata can operate—others are described below. This document now turns to an example environment in which the techniques can be embodied, after which example methods for performing the techniques are described.

### Example Environment

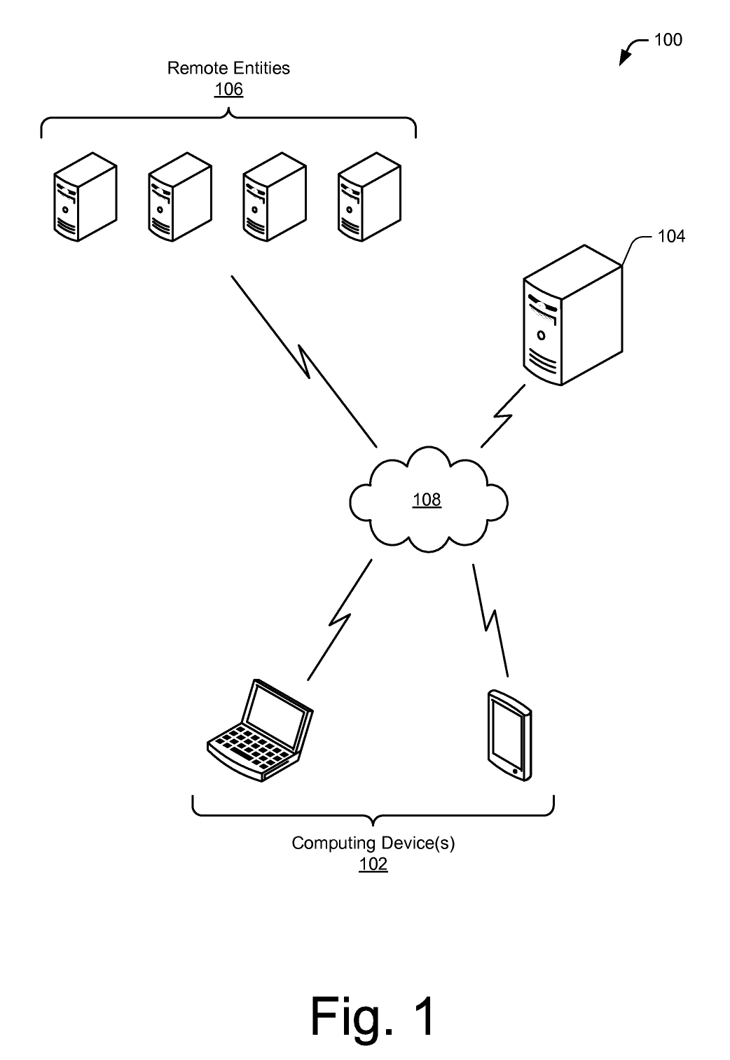

FIG. 1 is an illustration of an example environment 100 in which the techniques enable control or use of personal metadata. Environment 100 includes one or more computing device(s) 102, a remote device 104, remote entities 106, and a communication network 108. Computing device 102 and/or remote device 104 are capable of receiving and assembling personal metadata from entities 106, which computing device 102 presents to a user for use or control. Computing device 102, remote device 104, and remote entities 106 interact through communication network 108, which may include the Internet, a local-area network, a wide-area network, a wireless network, a USB hub, a computer bus, another mobile communications network, or a combination of these.

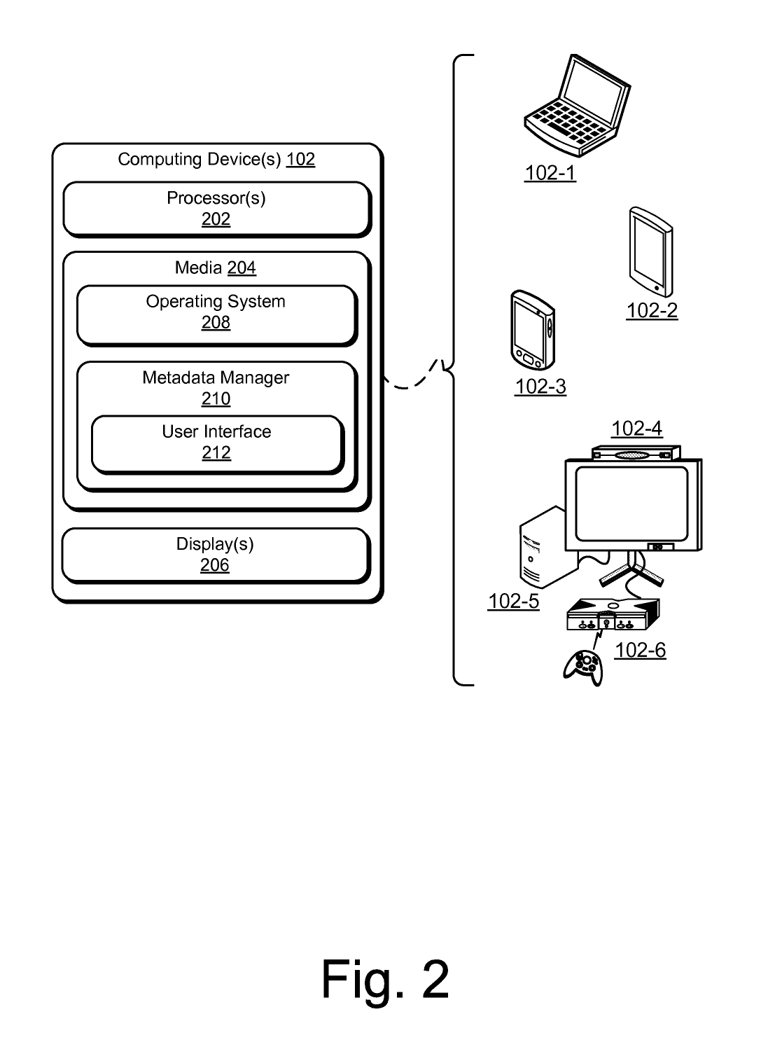

FIG. 2 illustrates an example embodiment of computing device 102 of FIG. 1, which is illustrated with six examples devices: a laptop computer 102-1, a tablet computer 102-2, a smart phone 102-3, a set-top box 102-4, a desktop computer 102-5, and a gaming device 102-6, though other computing devices and systems, such as servers and netbooks, may also be used.

Computing device 102 includes or has access to computer processor(s) 202, computer-readable storage media 204 (media 204), and one or more displays 206, four examples of which are illustrated in FIG. 2. Media 204 includes an operating system 208 and metadata manager 210.

Metadata manager 210 enables control or use of personal metadata either alone or in combination with other entities described herein. Metadata manager 210 includes or has access to user interface 212, which presents personal metadata and enables interaction with the metadata, such as graphical presentation and selection of metadata. Metadata manager 210, in response to a user's selection, alters a person's metadata.

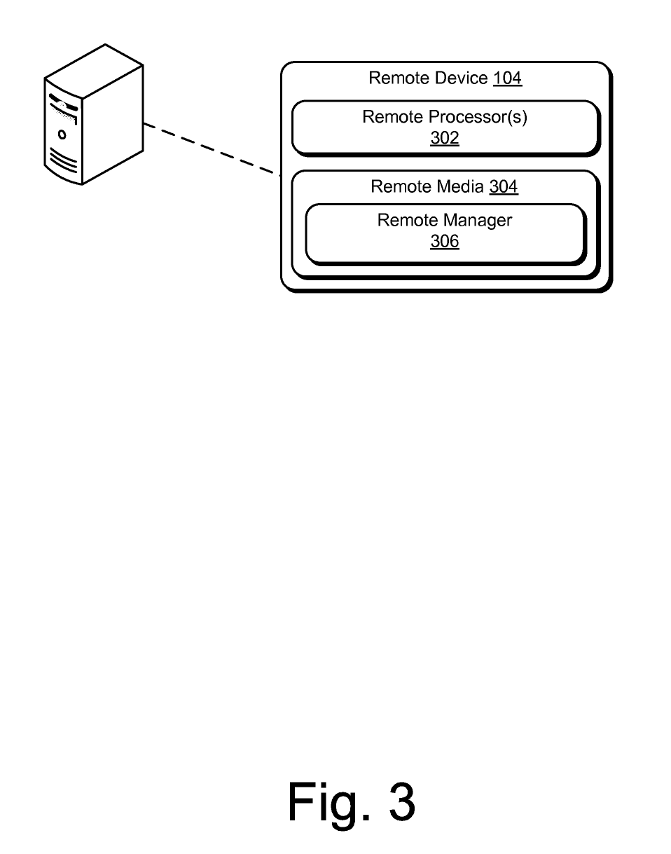

FIG. 3 is an illustration of an example embodiment of remote device 104. Remote device 104 includes one or more remote processors 302 and remote computer-readable storage media (“remote media”) 304. Media 304 includes or has access to a remote manager 306. Remote manager 306 enables control or use of personal metadata either alone or in combination with other entities described herein, such as metadata manager 210 and/or user interface 212. Like metadata manager 210, remote manager 306 may present, and enable selection to control, metadata through user interface 212 on computing device 102.

These and other capabilities, as well as ways in which entities of FIGS. 1-3 act and interact, are set forth in greater detail below. Note also that these entities may be further divided, combined, and so on. Thus, the environment 100 of FIG. 1 and the detailed illustrations of FIGS. 2 and 3 illustrate some of many possible environments capable of employing the described techniques.

### Example Methods

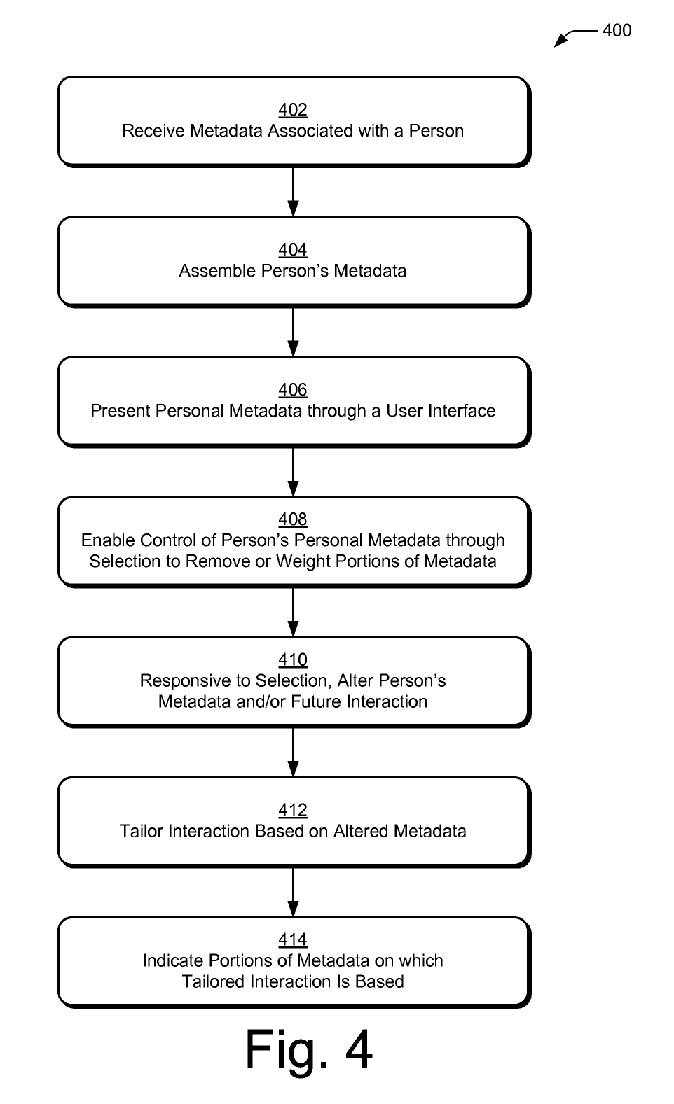

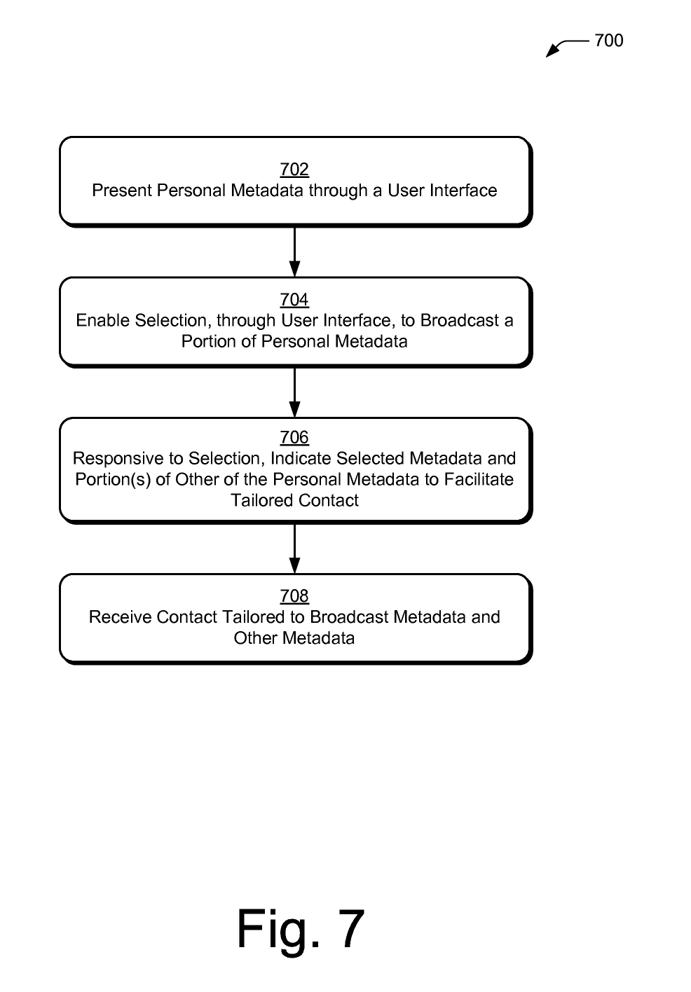

FIGS. 4 and 7 depict example methods 400 and 700, respectively, for enabling control or use of personal metadata, all or portions of which can be performed separate or in combination. These methods are shown as sets of blocks that specify operations performed but are not necessarily limited to the order shown for performing the operations by the respective blocks. In portions of the following discussion reference may be made to environment 100 of FIG. 1 and as detailed in FIGS. 2-3, reference to which is made for example only.

Block 402 receives, from one or multiple sources of metadata accessible through a communication network, metadata associated with a person. The personal metadata can be received passively or in response to queries to the sources.

As noted in part above, a person's metadata can be any information associated with the person available through the communication network. Examples of personal metadata include: a person's purchases made through the communication network; searches by the person; current or prior geographical locations of devices associated with the person; the person's demographics, such as age, gender, race, and marital status; the social network of the person, including other people's metadata in their network; explicitly selected preferences of the person; media use, such as downloaded songs or movies; and time-based metadata changes indicating a change or trend of the person, to name just a few.

The multiple sources of the personal metadata can be entities with which the person has or does not have an established relationship. Example entities with which a person has a relationship are those in which a person has a login, authenticator, or identity specific to the entity and the person (e.g., websites from which the person has bought an item or service, created a login, registered for emails, texts, or an RSS feed, and the like). Block 402 may determine the entities from which to request metadata, such as those that commonly have metadata or those that have an established relationship through searches or queries. Example entities having a person's metadata include entities that compile metadata, some search engines, and many entities that are associated with an entity having a relationship or that purchases/acquires metadata from these entities.

Continuing the example of Lydia noted above, metadata manager 210 and/or remote manager 306 of FIGS. 2 and 3, respectively (singularly or in combination “manager 210/306”), queries and then receives Lydia's metadata from ShoeStore.com, the search engine Lydia used, the social networking site Lydia joined and posted to, and likely many other entities that like would have some portions of Lydia's metadata received from one or more of these three entities.

Block 404 assembles the person's metadata from the multiple sources. While not required, assembling metadata can aid a person in seeing the metadata in groups or other assemblages making it easier for the person to understand and control the metadata. Thus, manager 210/306 may assemble metadata related to the person's demographics (age, etc.), social network, consumed media, most-visited entities, purchases, recent searches, and the like. Manager 210/306 may also or instead group metadata by influence on recommendations, searches, and other tailoring. If a person is concerned with privacy, for example, a demographic group can be a quick way for the person to see what demographic metadata exists, and thus to control it, without it being confused with, or having to search through, non-demographic metadata. If a person wants to be sure that her metadata has what she considers a correct amount of influence, groups shown by influence can be a quick way for the person to see and alter various influences.

Block 406 presents the personal metadata through a user interface. As noted, the presented metadata can be assembled in various ways for a user's convenience, including through a list of the metadata, by showing sources of the metadata, age and relevance of portions of metadata, influence of metadata, and metadata grouped by subject, to name just a few.

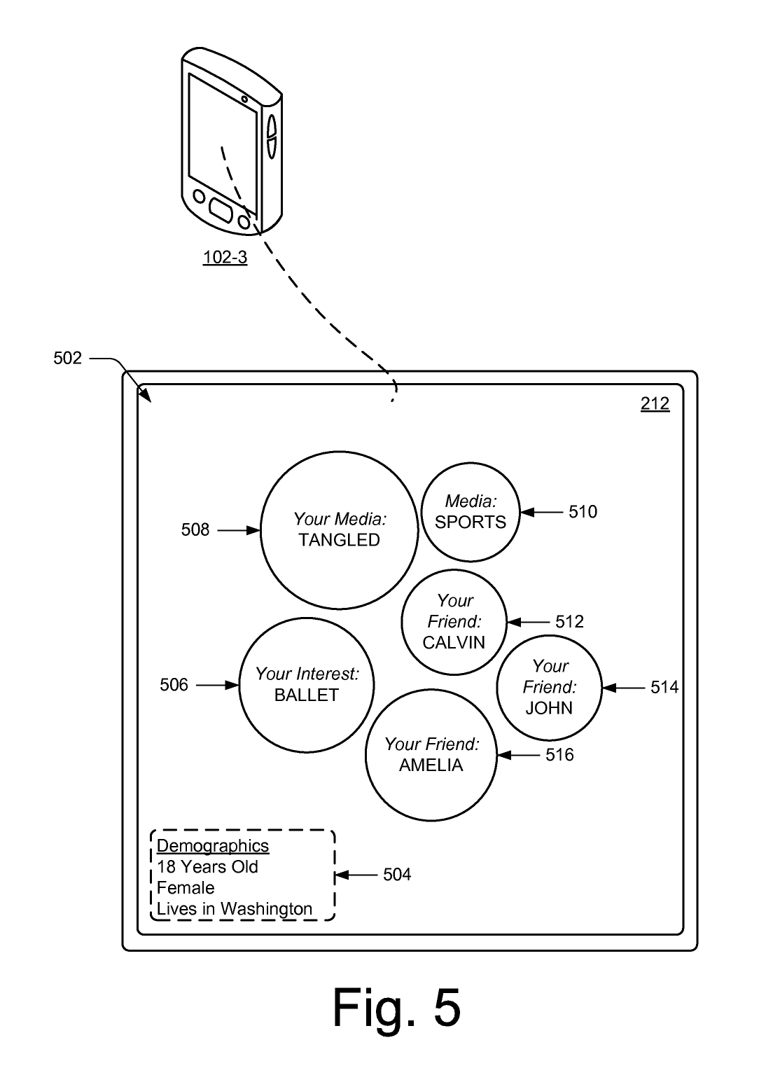

By way of example, consider FIG. 5, which illustrates user interface 212 having personal metadata 502 grouped by subject and influence. Demographic metadata is grouped by subject in a textual list at demographic group 504. Other metadata are grouped by name with each group's size indicating their relative influence on tailoring of Lydia's interactions, Internet presence, and/or experience. Influences are shown at influence groups 506, 508, 510, 512, 514, and 516, as “Your Interest: Ballet,” “Your Media: Tangled,” “Media: SPORTS,” “Your Friend: Calvin,” “Your Friend: John,” and “Your Friend: Amelia,” respectively. Here assume that Lydia, in the ongoing example, has made additional posts to her social network website that involve Calvin, John, and Amelia, and that she visited a sports website. Based on the previously mentioned interactions and these additional interactions, Lydia's metadata can be grouped as shown in FIG. 5.

Block 408 enables control of the person's metadata through selection to remove or weight a portion of the person's metadata presented in the user interface. For example, block 408 can enable a person to delete portions of their metadata or block portions from particular entities or even choose to expose metadata to new entities. Further, block 408 permits a person to weight various portions of metadata effective to alter that metadata's influence, as discussed above.

Continuing the ongoing example, consider again FIG. 5 and the various groups of metadata. Here assume that Lydia wants to reduce the influence of her friends Calvin and John because they often do not like the same things as she. Further, that Lydia wants to increase her friend Amelia's influence, as she and Amelia are best friends and often like the same things. Further still, assume that Lydia does not want entities on the Internet to know her age. Lydia, through user interface 212 as managed by manager 210/306, can simply select to remove “18 Years Old,” reduce the size of “Your Friend: Calvin” and “Your Friend: John,” and increase “Your Friend: Amelia.” User interface 212 permits Lydia to do this graphically or in other manners.

Block 408 may also enable selection to add metadata, such as presenting a data-entry field into which the person can enter metadata (e.g., “I like college basketball”) or options to quickly and easily select, such as a list of labels or graphics indicating the metadata (e.g., “golf,” “tennis,” “economy,” and “world events”).

Block 410, responsive to the selection, alters the portion of the person's metadata or a future interaction based on the person's metadata and the selection. If a person selects to alter or remove metadata, for example, block 410 can remove or alter the metadata locally and also remotely, such as by contacting the entities from which the metadata was received or other entities that may retain people's metadata. If the person selected to alter the metadata by adjusting an influence or weighting, the person's metadata may or may not be altered remotely, but can affect a future interaction.

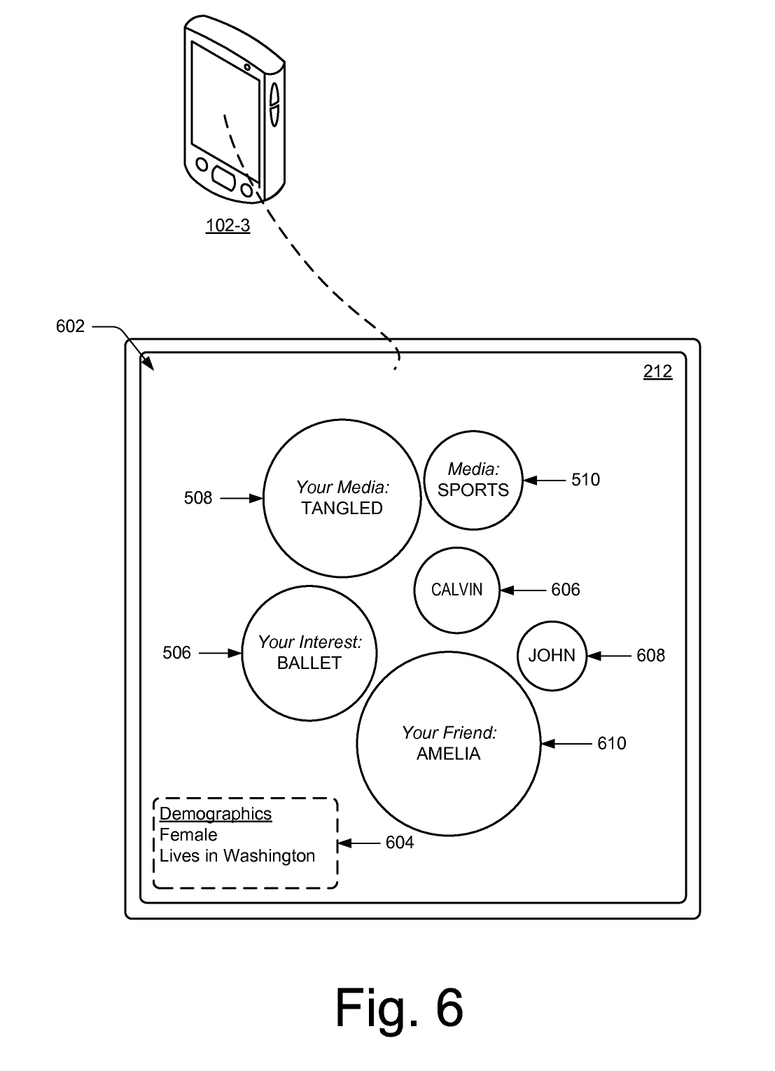

In the ongoing example, after making these selections, Lydia's personal metadata will be altered by manager 210/306 as noted below. FIG. 6 illustrates the result visually at altered, personal metadata 602. Note that the influence of various groups is now shown reduced or increased, as selected, and that Lydia's demographics do not include her age. These are shown at altered demographic group 604, and altered influence groups 606, 608, and 610, named: “Calvin,” “John,” and “Your Friend: Amelia,” respectively.

This control by Lydia over her personal metadata can result in a change to her metadata on the Internet by manager 210/306 contacting remote entities (such as remote entities 106 of FIG. 1), and requesting (or requiring) that the remote entities alter Lydia's metadata. Further, alterations affect how entities tailor Lydia's interactions. In the present example Lydia reduced the influence of Calvin and John but increased Amelia's influence. Based on metadata about Calvin and John indicating that they like baseball and that Amelia likes tennis, a recommendation from a remote entity for an activity to go to or an article to read may state: “Join U.S. Tennis Association's Junior Tennis League” when, before Lydia's alteration, the recommendation instead would have stated: “Local AAA Baseball Team Playoffs Start Monday.”

Additionally, method 400 may proceed to block 412, which tailors an interaction based on the altered metadata. In some embodiments, manager 210/306 acts to facilitate a person's interactions with remote entities 106. In such a case, manager 210/306 can provide altered metadata to search engines, sales websites, or other entities so that these entities are better able to tailor Lydia's interactions with them. Further still, manager 210/306 may manage these interactions, such as by receiving search results and presenting the results in user interface 212 or another local interface (e.g., a web browser interacting with manager 210/306).

Block 414 indicates portions of a person's metadata on which an interaction is based. Thus, manager 210/306 can show on what metadata a search result or recommendation, such as to join a tennis league or see a particular movie, was based. By so doing, a person may learn how interactions are altered by the person's metadata, allowing them to better know how to control their metadata and thus their interactions.

Concluding the current example, manager 210/306, through user interface 212, presents the recommendation: “Join U.S. Tennis Association's Junior Tennis League” along with a textual and/or visual explanation indicating that this recommendation was based on Lydia's friendship with Amelia, who likes tennis.

Before moving to the description of method 700, consider another example in the context of method 400. Assume that someone, such as a father of four children ages 5 to 20, has extensive personal metadata a lot of which is directed to his interactions for others, such as his wife and four children. If the father's metadata has many influences (see FIG. 5) or inaccuracies, which can often be the case, the techniques permit him to control his metadata, even temporarily. Consider a case where his metadata shows that he likes pre-teen novels about vampires. Assume also that this metadata is actually from his 12-year-old daughter using his account at a book-selling website. He may choose to remove this metadata or temporally reduce or remove its influence. If he is looking for a new book, for example, the techniques permit him to remove the influence of pre-teen novels for the purpose of his current search or surfing session. By so doing, his search result may properly indicate books on economics and not vampires. Likewise, a parent that commonly buys toys for a four-year-old boy can remove the influence of Thomas the Tank Engine from her interactions, even for a single interaction or session.

FIG. 7 depicts a method 700 for enabling control or use of personal metadata, where the control or use results in broadcast of personal metadata to one or more entities. Ways in which operations are performed in method 700 may also be applied to the techniques generally and operations of method 400, and vice-a-versa.

Block 702 presents personal metadata through a user interface, the personal metadata from one or more sources accessible through a communication network and/or that is locally stored. Block 702 may operate similarly to block 406 of FIG. 4, and may be preceded by blocks 404 and/or 402.

Block 704 enables selection, through the user interface, to broadcast a portion of the metadata to one or more entities through the communication network, the broadcast indicating an explicit request for contact by the one or more entities. Manager 210/306, for example, may enable entry of new metadata or alteration of metadata or simply a selection of a group of metadata for broadcast to appropriate entities. Returning to FIG. 5, for example, consider influence group 508, which shows the influence of Lydia's metadata associated with the animated movie Tangled. At block 704, manager 210/306 enables selection of this influence group 508 for broadcast. Assume that Lydia would like to know more about the movie (e.g., that it is based on the novel Rapunzel), or receive recommendations for similar movies to purchase or rent. Simply by selecting influence group 508 for broadcast, she can explicitly request contact by appropriate entities.

Block 706, responsive to the selection to broadcast metadata, provides, to the one or more entities, the selected, broadcast metadata and other portions of the person's metadata to facilitate contact. The other portions of the person's metadata are usable by the one or more entities to tailor the contact in addition to the broadcast portion of the metadata. Manager 210/306 can determine which entities are appropriate for this request, such as booksellers.com and netmovie.com. Manager 210/306 provides metadata associated with the selection, such as “Tangled, animated Movie, released 2010,” to each of these websites but also relevant portions of Lydia's other metadata, such as “interests include ballet and tennis.”

Further still, the techniques may forgo some metadata, such as Lydia's identity and other demographic information to protect Lydia or because it simply isn't relevant.

Block 708 receives contact, tailored to the broadcast portion and other portions of the metadata, from the one or more entities and presents the contact. In some cases method 700 ends at block 706, in which case a web browser or other entity presents the contact. Method 700 may proceed to block 708, however, in which case manager 210/306 receives and presents the contact. The contact may be presented through user interface 212 or otherwise.

Continuing the ongoing example, assume that both booksellers.com and netmovie.com indicate items to purchase, such as the book version of Tangle and the novel on which it was based, Rapunzel, from booksellers.com and similar movies for download from netmovie.com. Manager 210/306 may present these contacts with or without these entities knowing to which person they are directed. This protects Lydia from future contact by these entities should she choose not to purchase from them.

Further still, manager 210/306 may enable a person to purchase an item or interact with an entity offering a contact through manager 210/306, and thus without undue metadata passing to the entity. Thus, Lydia may purchase Rapunzel without establishing a relationship that indicates much of her personal metadata. In this example, manager 210/306, responsive to selection to purchase the item, provides purchasing information to the entity, receives a purchase confirmation, and presents the purchase confirmation to Lydia.

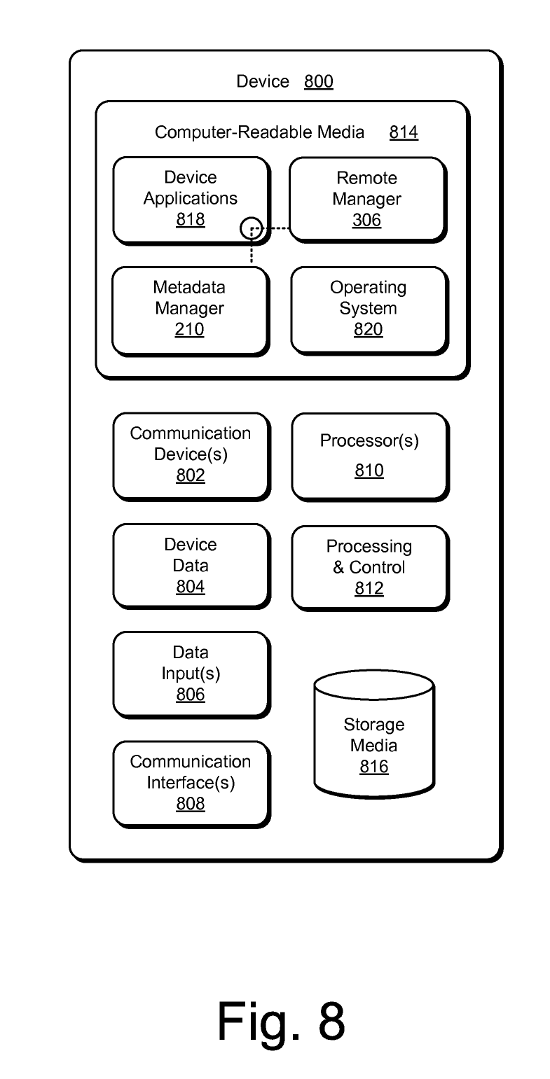

These techniques may be embodied on one or more of the entities shown in environment 100 of FIG. 1 including as detailed in FIG. 2 or 3, and/or example device 800 described below, all of which may be further divided, combined, and so on. Thus, environment 100 and/or device 800 illustrate some of many possible systems or apparatuses capable of employing the described techniques. The entities of environment 100 and/or device 800 generally represent software, firmware, hardware, whole devices or networks, or a combination thereof. In the case of a software implementation, for instance, the entities (e.g., metadata manager 210 and remote manager 306) represent program code that performs specified tasks when executed on a processor (e.g., processor(s) 202 and/or 302). The program code can be stored in one or more computer-readable memory devices, such as media 302 and/or 304 or computer-readable media 814 of FIG. 8.

### Example Device

FIG. 8 illustrates various components of example device 800 that can be implemented as any type of client, server, and/or computing device as described with reference to the previous FIGS. 1-7 to implement techniques for enabling control or use of personal metadata. Device 800 can be implemented as one or a combination of a wired and/or wireless device, as a form of television mobile computing device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 800 may also be associated with a user (e.g., a person) and/or an entity that operates the device such that a device describes logical devices that include users, software, firmware, and/or a combination of devices.

Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as human utterances, user-selectable inputs, messages, music, television media content, recorded video content, and any other type of audio, video, and/or image data received from any content and/or data source.

Device 800 also includes communication interfaces 808, which can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like), which process various computer-executable instructions to control the operation of device 800 and to enable techniques for enabling control or use of personal metadata. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable storage media 814, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include a mass storage media device 816.

Computer-readable storage media 814 provides data storage mechanisms to store the device data 804, as well as various device applications 818 and any other types of information and/or data related to operational aspects of device 800. For example, an operating system 820 can be maintained as a computer application with the computer-readable storage media 814 and executed on processors 810. The device applications 818 may include a device manager, such as any form of a control application, software application, signal-processing and control module, code that is native to a particular device, a hardware abstraction layer for a particular device, and so on.

The device applications 818 also include any system components, engines, or modules to implement techniques for enabling control or use of personal metadata. In this example, the device applications 818 can include metadata manager 210 or remote manager 306, either of which can interact with a user interface, such as user interface 212 of FIG. 2.

### CONCLUSION

Although embodiments of techniques and apparatuses enabling control or use of personal metadata have been described in language specific to features and/or methods, it is to be understood that the subject of the appended claims is not necessarily limited to the specific features or methods described. Rather, the specific features and methods are disclosed as example implementations for enabling control or use of personal metadata.

What is claimed is:

1. A computer-implemented method comprising:
presenting a person's metadata in a user interface, the person's metadata from multiple sources accessible through a communication network;
enabling control of the person's metadata through selection to remove or weight a portion of the person's metadata presented in the user interface; and
responsive to the selection, altering the portion of the person's metadata or a future interaction made through the communication network based on the person's metadata.

2. A computer-implemented method as described in claim 1, wherein altering the portion of the person's metadata alters metadata at one of the multiple sources.

3. A computer-implemented method as described in claim 1, wherein altering the portion of the person's metadata is effective to alter the future interaction.

4. A computer-implemented method as described in claim 1, wherein the altering is temporary effective to alter the future interaction but not the person's metadata.

5. A computer-implemented method comprising:
presenting a person's metadata in a user interface, the person's metadata from one or more sources accessible through a communication network;
enabling selection, through the user interface, to broadcast a portion of the person's metadata to one or more entities through the communication network, the broadcast indicating an explicit request for contact by the one or more entities; and
responsive to selection to broadcast the portion of the person's metadata, providing, to the one or more entities, the portion of the person's metadata and other portions of the person's metadata, the other portions of the person's metadata usable by the one or more entities to tailor the contact.

6. A computer-implemented method as described in claim 5, wherein providing the portion of the person's metadata and the other portions does not include information indicating an identity of the person.

7. A computer-implemented method as described in claim 5, further comprising receiving a contact tailored to the portion and the other portions of the person's metadata and, responsive to receiving the contact, presenting the contact in the user interface.

8. A computer-implemented method as described in claim 7, further comprising:
enabling selection to make a purchase associated with the contact and associated with an entity of the one or more entities from which the contact is received; and
responsive to selection to make the purchase:
providing purchasing information to the entity;
receiving a purchase confirmation; and
presenting the purchase confirmation.

9. A computer-implemented method as described in claim 5, further comprising:
receiving, from one of the entities to which the portion of the person's metadata is provided, an offer to purchase an item or service selected based on the portion and the other portions of the person's metadata; and
presenting the offer through a second user interface or the first-mentioned user interface.

10. A computer-implemented method comprising:
receiving, from multiple sources of metadata accessible through a communication network, metadata associated with a person;
assembling the person's metadata from the multiple sources;
presenting the assembled metadata in a user interface;
enabling control of the person's metadata through selection to remove or weight a portion of the assembled metadata presented in the user interface; and
responsive to the selection, altering the assembled metadata effective to alter the person's metadata or a future interaction based on the person's metadata.

11. A computer-implemented method as described in claim 10, further comprising presenting, as part of the future interaction, a search or a recommendation based on the person's metadata.

12. A computer-implemented method as described in claim 11, further comprising indicating on what portions of the person's metadata the future search or the recommendation is based and enabling selection to alter the portions.

13. A computer-implemented method as described in claim 10, wherein receiving metadata associated with a person includes determining the multiple sources and querying the multiple sources for the person's metadata.

14. A computer-implemented method as described in claim 10, wherein the multiple sources include entities with which the person has an established relationship, the established relationship including an identity, login, or authenticator specific to the person.

15. A computer-implemented method as described in claim 10, wherein assembling the person's metadata groups the person's metadata into two or more groups, and presenting the assembled metadata presents the assembled metadata in the two or more groups.

16. A computer-implemented method as described in claim 15, further comprising enabling selection to hide or expose one or more of the groups or portions thereof to one or more entities accessible through the communication network.

17. A computer-implemented method as described in claim 15, further comprising presenting, in the user interface, a relative influence of each of the groups on current or future searches requested by the person or recommendations made to the person.

18. A computer-implemented method as described in claim 17, further comprising enabling selection to alter the relative influence of at least one of the person's metadata groups on the future interaction.

19. A computer-implemented method as described in claim 17, wherein presenting the relative influence presents respective influences of the groups based on sizes of graphics associated with the groups.

20. A computer-implemented method as described in claim 10, further comprising enabling selection, through the user interface, to broadcast metadata, the broadcast indicating an explicit request for contact by one or more entities through the communication network.
